(19) United States
(12) Patent Application Publication
(10) Pub. No.: US 2024/0317148 A1
(43) Pub. Date: Sep. 26, 2024

(54) Fastening Arrangement for Cameras Disposed in Vehicle Spoilers

(71) Applicant: Bayerische Motoren Werke Aktiengesellschaft, Muenchen (DE)

(72) Inventor: Nicholas ALDERSLEY, Hebertshausen (DE)

(21) Appl. No.: 18/578,807

(22) PCT Filed: Jul. 11, 2022
(86) PCT No.: PCT/EP2022/069297

§ 371 Date: Jan. 12, 2024

(30) Foreign Application Priority Data
Jul. 16, 2021 (DE) 10 2021 118 446.0

(51) Int. Cl. B60R 11/04; B60R 11/00; B60S 1/52; B62D 35/00; G03B 17/56

(52) U.S. Cl. CPC B60R 11/04; B60S 1/52; B62D 35/007; G03B 17/561; B60R 2011/0059

(57) ABSTRACT

A fastening arrangement for a camera, which is disposed inside a spoiler to be fastened to a region of a body or of a tailgate panel of a vehicle, includes a camera support which is fastened to the exterior of the body or to a tailgate panel of the vehicle before the spoiler is mounted, and has a camera disposed therein, in such a way that a lens of the camera looks outside the vehicle. The spoiler is formed in such a way that it has a cutout for the lens of the camera and fasteners for fastening to the body or to the tailgate panel. During mounting, the spoiler is fastened over the camera support and the camera in such a way that, after being mounted on the lens, it is aligned with regard to the body or the tailgate panel.

### BACKGROUND AND SUMMARY

The invention relates to a fastening arrangement for cameras which are arranged in vehicle spoilers.

The use of cameras for detecting the immediate surroundings of vehicles is known. Thus, for example, reversing cameras are used to assist a driver, for example, during the parking operation. The arrangement and fastening types of a reversing camera are different from manufacturer to manufacturer and partially also from vehicle model to vehicle model. For example, merely one reversing camera can be arranged on the rear region of the vehicle, which reversing camera is provided such that it is either always visible or can be deployed from behind an emblem. If the vehicle provides a 360° view (bird's eye view), further cameras can be present in the front region and in the exterior mirrors. It is also already known, for example, from US 2019/0237 866 A1 for a combination of an antenna system and a camera system to be provided in what is known as a shark fin arrangement on the roof of a vehicle, it being necessary here for the problem of mutual electrical influencing of the antenna and the camera to be solved.

Cameras which are attached in the rear region of the vehicle are integrated into functional elements such as buttons, cover panels or the like, or are fastened directly to the tailgate by way of an at least partially visible holder. Reversing cameras are frequently arranged in a spoiler which is provided on an upper region of the tailgate of the vehicle, as is known from US 2020/0108877 A1, for example. This has the advantage that merely the camera lens is visible from the outside, but its housing with the electronics and the cabling is concealed in the cavity between the spoiler and the tailgate panel.

The fastening of a camera in a rear spoiler takes place by the camera first of all being fastened in the spoiler and then being mounted together with the spoiler on the vehicle shell.

It is an object of this invention to provide an improved fastening arrangement for cameras arranged in vehicle spoilers. According to the invention, this object is achieved by way of the features of the independent patent claims. Advantageous refinements are the subject matter of the dependent claims.

In the case of a camera integration into a (large) rear spoiler, the camera and possibly its support (camera support) have to be fastened within the spoiler. Merely the lens is visible from outside the spoiler. Here, a water-tight interface, in particular of the cabling, toward the camera has to be ensured. Up to now, this has taken place by way of corresponding plug-in connections and/or sealing methods for individual braids, depending on the type of cable used. On account of the mounting, in the case of which the camera is fastened to the spoiler and is only then connected to the tailgate panel, the position of the camera is defined solely by way of the spoiler, moreover. In the case of an adhesive bond between the spoiler and the camera support with respect to the tailgate panel, furthermore, the seal of the camera support can be impaired by tolerance deviations. In order to improve these problems, an improved fastening arrangement for a spoiler camera of a vehicle is proposed in the following text.

A fastening arrangement for a camera which is arranged within a spoiler to be fastened on a region of a vehicle body or a tailgate panel of a vehicle is proposed, having a camera holder which is fastened in a water-tight manner to the outer side of the vehicle body or to a tailgate panel of the vehicle before the spoiler is mounted, with a camera which is fastened in a water-tight manner and arranged therein in such a way that a lens of the camera looks out of the vehicle. The spoiler is formed in such a way that it has a recess for the lens of the camera and fastening means for fastening to the vehicle body or to the tailgate panel, this spoiler, upon mounting, being fastened above the camera holder and the camera in such a way that, after mounting, it is aligned on the lens in relation to the vehicle body or the tailgate panel. By way of the proposed fastening arrangement, a camera can be mounted in a simple way at a spacing from the vehicle body and from outside the vehicle body.

It is provided, furthermore, that the camera support terminates in a water-tight manner with respect to the vehicle body or the tailgate panel and with respect to the camera. In this way, the cables can be routed in the dry region, and no complicated seal is necessary for this purpose.

It is provided, furthermore, that the fastening means are formed as slide nuts, and the vehicle body or the tailgate panel has screw connections which correspond to the slide nuts. In this way, the spoiler is fastened securely, but can compensate for tolerances, for example, on account of thermal expansion. Moreover, it can be aligned on the lens in this way.

It is provided, furthermore, that a sleeve is provided which can be applied over the lens to the camera or the camera holder before mounting of the spoiler, and is in contact with the recess of the spoiler for the lens at least on part regions thereof after mounting and is not in contact with the lens. In this way, the sensitive lens can be protected against mechanical loading, but an alignment of the spoiler on the lens can nevertheless take place. Moreover, a gap or a joint between the lens (or its housing) and the camera support can thus be reduced and/or covered.

It is provided, furthermore, that the sleeve has clips, by way of which the sleeve can be fastened to the camera holder in order to fix the camera on the latter. Therefore, the sleeve can be fastened in a simple but effective way.

It is provided, furthermore, that a washer nozzle is fastened to the vehicle body or the tailgate panel adjacently with respect to the camera, the spoiler having a separate recess for the washer nozzle. Therefore, the lens can be cleaned in an automated manner as required.

Furthermore, the use of the fastening arrangement on a spoiler on a rear side of a vehicle is provided.

It is provided, furthermore, that the fastening arrangement and the spoiler are arranged as an upper rear spoiler or a lower rear spoiler. That is to say, the fastening arrangement and the spoiler are arranged above a rear-side window pane, and/or, if the window pane is integrated into a tailgate, below a rear-side window pane, or at the outer end of a trunk 11d.

Furthermore, a vehicle is proposed, having the above-described fastening arrangement.

Furthermore, a mounting method of the above-described fastening arrangement is proposed, in a first step, the camera being fastened in a water-tight manner in the camera holder, and, in a second step, the camera holder being fastened in a water-tight manner to the vehicle body or the tailgate panel of the vehicle, and, in a third step, the spoiler being fastened to the vehicle body or the tailgate panel above the camera holder with the recess above the lens in such a way that, after mounting, it is aligned on the lens in relation to the vehicle body or the tailgate panel.

Further features and advantages of the invention result from the following description of exemplary embodiments of the invention, on the basis of the figures of the drawing which shows details according to the invention, and from the claims. The individual features can each be implemented individually per se or in multiples in any desired combination in a variant of the invention.

Preferred embodiments of the invention will be explained in greater detail in the following text on the basis of the appended drawings.

### BRIEF DESCRIPTION OF THE DRAWINGS

FIG. 1 is a diagrammatic sectional view of important components of the fastening arrangement in accordance with one embodiment of the present invention.

FIG. 2 is a view of a camera in accordance with one embodiment of the present invention, which is fastened to a camera support that is connected to the tailgate panel.

FIG. 3 is a diagrammatic sectional view of a camera with a sleeve in accordance with one embodiment of the present invention, which camera is fastened to a camera support that is connected to the tailgate panel.

FIG. 4 is a view of a sleeve in accordance with one embodiment of the present invention, which is applied to a camera.

FIG. 5 is a view of a tailgate with a camera in accordance with one embodiment of the present invention, which is arranged in a lower spoiler.

FIG. 6 is a diagrammatic illustration of the sequence of the mounting method in accordance with one embodiment of the present invention.

In the following descriptions of the figures, identical elements and functions are provided with identical designations.

### DETAILED DESCRIPTION OF THE DRAWINGS

The term spoiler 40 is to be understood to mean both classic spoilers 40 which serve for aerodynamics, and spoilers 40 which serve at least partially for decoration, that is to say regions which intentionally project from the vehicle body 1 and behind which a cavity is situated which is provided with a covering as cover. Spoilers 40 of this type are as a rule provided on the rear region of a vehicle.

Therefore, the invention is shown using the example of a fastening arrangement on a region of a tailgate (which also includes a rear door) of a vehicle. The fastening arrangement for a camera 30 can also be provided on different regions of a vehicle, however, on which a camera 30 is to be fastened within a spoiler 40.

Spoilers 40 are usually provided on the upper region of the tailgate as an upper rear spoiler, but can also be provided on regions below the rear window (fastback, SUV, generally vehicles with a steeply running rear window) or at the rear end of a trunk lid (notchback vehicles, generally vehicles with a trunk lid which is separate from the rear window) as a lower rear spoiler 2. Lower rear spoilers 2 can also be called Gurney flaps.

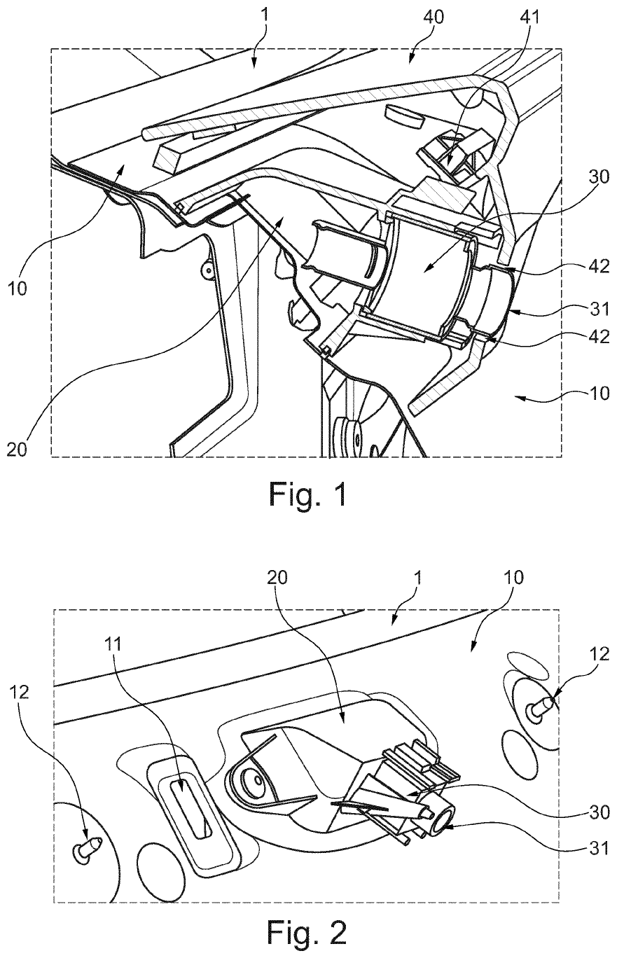

The basic concept of the invention is that the camera 30 which is provided within the spoiler 40 is fastened to a camera support 20 which is connected in a water-tight manner to the vehicle body 1, as shown in the sectional illustration in FIG. 1. In the case of a tailgate, the vehicle body 1 corresponds to the tailgate outer skin or the tailgate panel 10. The spoiler 40 is mounted above it as a completely separate (that is to say, independent) element, and is fastened independently of the camera 30 to the vehicle body 1 or tailgate outer skin (tailgate panel 10). It has merely one recess 42 for the lens 31 of the camera 30. As a result of the separate mounting of the spoiler 40 and the camera support 20, the camera 30 is aligned in relation to the vehicle body 1 and not to the spoiler 40, and manufacturing tolerances of the spoiler 40 no longer have an effect on the alignment of the camera 30. Moreover, the mounting method is simplified as a result, and complicated cable sealing is no longer necessary, since the cables are situated in what is known as the dry region. This will be explained in more detail in the following text.

As has already been mentioned, the camera 30 is fastened to the tailgate panel 10 (in the case of mounting on the tailgate) and therefore the vehicle body 1 completely separately from the spoiler 40 with its own alignment and its own seal. The tailgate is connected to the vehicle body 1, in order to ensure the movability of the tailgate. In this regard, the tailgate and the vehicle body 1 are used synonymously here.

The camera support 20 is a pure functional part without visible surfaces from the outside (since it is concealed by the spoiler 40) and can advantageously be fastened, for example screwed, in a water-tight manner from the outside to the tailgate panel 10. The spoiler 40 is guided over it afterward and is fastened to the vehicle body 1 or the tailgate panel 10 (in the case of the arrangement on a tailgate). The alignment of the spoiler 40 therefore takes place on the camera 30 and not, as up to now, the other way around. The fastening of the spoiler 40 can take place either via screw connections 12 on the tailgate panel 10 and corresponding fasteners 41, for example slide nuts, which are formed as counterparts on the spoiler 40 or via, for example, pins and guides on the camera support 20. The fasteners 41 on the spoiler 40 are formed in such a way that they are connected movably to the screw connections 12 for mounting purposes. This makes tolerance and stress compensation during mounting (or more precisely the alignment with the camera) possible, and even in the case of a thermal deformation of the spoiler 40. The spoiler 40 therefore influences neither the position, mounting, nor seal of the camera 30 or its camera support 20.

In one embodiment, the fasteners 41 which are formed as slide nuts are pre-mounted in the spoiler 40. When the screws of the screw connections 12 are tightened, the slide nuts remain at the same location on the spoiler 40, since they are then screwed to it, and the spoiler 40 then slides on the slide nuts.

The opening 11 which has served up to now as mounting aid for the spoiler 40 can therefore be considerably smaller than previously.

Up to now, the camera 30 has first of all been mounted on the spoiler 40, which camera is invisible in the mounted state. The spoiler 40 has then been aligned together with the camera 30 mounted on it over an opening 11 on the tailgate panel 10 and fastened to the latter. An additional fastening has taken place via screw connections 12 to the tailgate panel 10, and via corresponding fasteners 41 which are formed as counterparts on the spoiler 40, as also provided according to the invention in a manner which is adapted to the new fastening type and shown in FIG. 2.

A disadvantage of mounting the camera support 20 with the camera 30 on the spoiler 40 is that the seal of the camera support 20 can be impaired by tolerance deviations during the fastening to the tailgate panel 10, and that the position of the camera 30 is defined by the spoiler 40. Moreover, the electric cabling is problematic. This has to be water-tight, since it is situated in the wet region within the spoiler 40 (that is to say in the cavity between the vehicle body and the spoiler 40 or outer cover). Water-tight plugs therefore have to be provided which can in part be very thick, which makes routing the cables from inside the vehicle body 1 via the provided leadthroughs toward the spoiler 40 more difficult. The required cable length is also a problem, since a greater length is necessary for mounting of the camera 30 than subsequently in the installed state. This excess length has to be concealed within the cavity of the spoiler 40, which involves additional mounting effort. A further problem of the fastening of the camera support 20 is that the outer skin of the spoiler 40 itself is very thin, with the result that the camera support 20 cannot be screwed to it as is possible, for example, in the case of cameras in the relatively thick plastic of exterior mirrors.

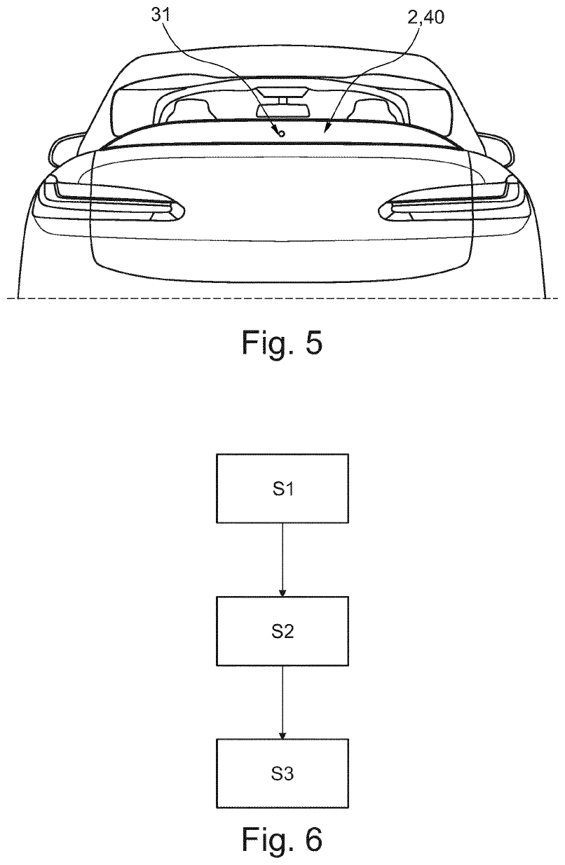

In the case of cameras in the prior art which are fastened directly to the vehicle body 1, the camera support is provided within the vehicle body 1 and only the lens 31 of the camera 30 looks out. It is therefore flush with the outer skin of the vehicle. Cameras 30 are also available which look slightly out of the vehicle body 1 as an attachment part, that is to say provided with a covering. As has already been described, these are fastened in such a way that the vehicle body 1 is between the lens 31 and the housing of the camera 30. This can be appropriate in many cases, but not in all cases. In particular, if the field of vision for the camera 30 is restricted on account of the vehicle body shape, as shown in FIG. 5 on the basis of a lower rear spoiler 2, that is to say a spoiler 40 on the lower region of the tailgate of the vehicle, the camera 30 cannot necessarily be arranged flush with the vehicle body 1. Previous cameras 30 either do not project from the vehicle body 1, however, since the housing of the camera 30 is not provided on the outer region of the vehicle, as provided according to the invention, or are mounted in a spoiler 40 in a complicated manner, or are mounted as a visible attachment part directly on the outer region of the vehicle.

Up to now, there has been no camera 30 which is simple to mount and is provided within a spoiler 40, in particular a lower rear spoiler 2. As a result of the proposed fastening arrangement, there is the advantage in comparison with previously known cameras 30 which were mounted in spoilers 40 that the cables are always routed in the dry region, since they are routed within the camera support 20 which is connected in a water-tight manner (for example, by means of corresponding seals) to the vehicle body 1 and afterward in the interior region of the vehicle body 1. The camera 30 is likewise fastened in the camera support 20 in a water-tight manner. Therefore, no complicated seal of individual cables or braids is necessary. No excess length of the cables is necessary either on account of the direct mounting of the camera support 20 on the tailgate panel 10 or the vehicle body 1. Therefore, the mounting is simplified in several ways.

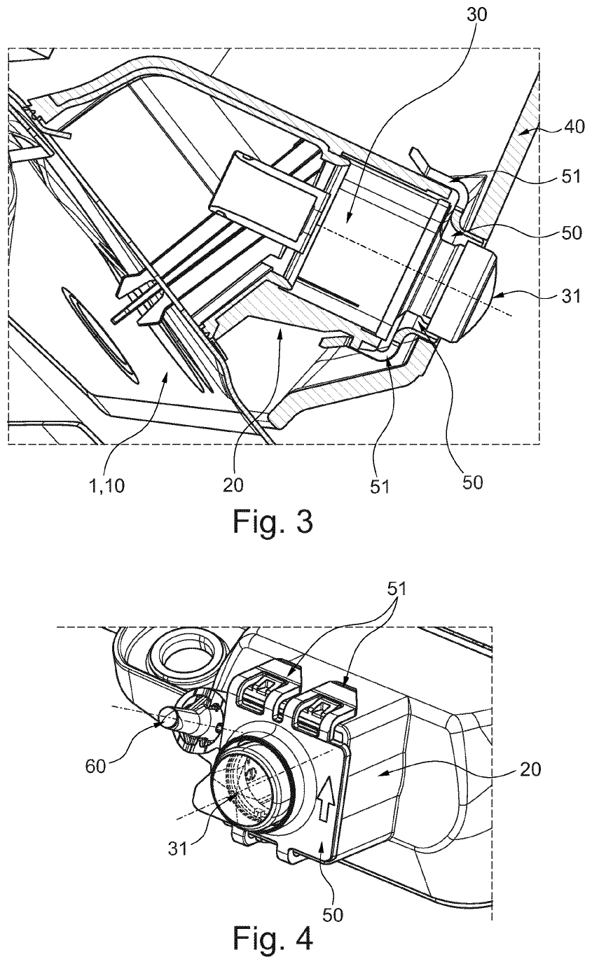

Since the lens 31 is very sensitive to contact and generally mechanical loading, a sleeve 50 which serves at the same time as a centering sleeve and is applied over the lens 31, as shown in FIGS. 3 and 4, can also be provided in a further embodiment. This sleeve therefore serves both to protect the lens 31 and also to visually compensate for the great tolerance required on account of the independent connection of the camera 30 or camera support 20 and the spoiler 40 to the tailgate panel 10 and therefore the large and partially also asymmetrical recess 42, that is to say the joint to the lens 31. For this purpose, the sleeve 50 is fastened without play (that is to say in contact with) to the camera support 20, but has play with respect to the lens 31, with the result that tolerances between the lens 31 and its housing do not lead to any bracing against the lens 31. The sleeve 50 protrudes into the joint of the recess 42 between the camera 30 and the spoiler 40, and permits an alignment of the spoiler 40 with contact with the sleeve 50 including load, but without loading the lens 31 with this force. At the same time, it therefore conceals large parts of the joint, with the result that housing parts, etc. which lie behind it are concealed to the outside as satisfactorily as possible.

In one embodiment, the sleeve 50 can also serve as a fixing device of the camera 30 on the camera support 20, as shown in FIGS. 3 and 4, for example. For this purpose, clips 51 can be provided, by way of which the sleeve 50 can be clipped over the camera support 20.

In a further embodiment, a washer nozzle 60 can be provided to clean the lens 31. Here, depending on the embodiment, the washer nozzle 60 is provided adjacently with respect to the lens 31, but in a separate recess in the spoiler 40. It is also fastened to the tailgate panel 10 or the vehicle body 1, and is therefore likewise independent of the spoiler 40. The washer nozzle 60 is arranged and constructed in such a way that it can clean the lens 31 as required. For this purpose, the washer nozzle 60 can also be formed in an extendable manner.

The invention has been described with regard to merely one camera 30 which is installed in a spoiler 40. It is also possible, however, for a plurality of cameras 30 to be installed in a spoiler 40 which can also have other alignments, in order to cover, for example, a greater region of the rear side of the vehicle.

In all cases, the camera 30 serves to provide the driver with an improved view over their vehicle and the immediate surroundings, for example during parking. In future applications, cameras 30 can also be used on the exterior region of the vehicle for highly automated and autonomous driving, for example in order to realize a collision warning.

As has already been described, the mounting method is considerably simplified in comparison with previous mounting methods. The mounting method of the above-described fastening arrangement namely takes place, as shown in FIG. 6, by, in a first step S1, the camera 30 being fastened in a water-tight manner in the camera holder 20, and, in a second step S2, the camera holder 20 being fastened in a water-tight manner to the vehicle body 1 or the tailgate panel 10 of the vehicle, and, in a third step S3, the spoiler 40 being fastened to the vehicle body 1 or the tailgate panel 10 above the camera holder 20 with the recess 42 above the lens 31 in such a way that, after mounting, it is aligned on the lens 31 in relation to the vehicle body 1 or the tailgate panel 10.

### LIST OF DESIGNATIONS

1 Vehicle body
2 Lower rear spoiler
10 Tailgate panel
11 Opening for orienting the spoiler
12 Screw connections for spoiler
20 Camera holder
30 Camera
31 Lens
40 Spoiler
41 Fastening means or counterparts to 12
42 Recess for 31
50 Sleeve
51 Clips
60 Washer nozzle

1.-10. (canceled)

11. A fastening arrangement for a camera on a vehicle, comprising:
a spoiler for the vehicle;
a camera holder which is fastened in a water-tight manner to an outer side of a vehicle body or to a tailgate panel of the vehicle before the spoiler is mounted, wherein the camera holder has the camera, fastened in a water-tight manner, arranged therein such that a lens of the camera looks out of the vehicle, wherein
the spoiler is formed so as to have a recess for the lens of the camera and fasteners for fastening to the vehicle body or to the tailgate panel, and
the spoiler, upon mounting, is fastened over the camera holder and the camera such that, after mounting, the spoiler is aligned on the lens in relation to the vehicle body or the tailgate panel.

12. The fastening arrangement according to claim 11, wherein
the camera support terminates in a water-tight manner with respect to the vehicle body or the tailgate panel and with respect to the camera.

13. The fastening arrangement according to claim 11, wherein
the fasteners are formed as slide nuts, and
the vehicle body or the tailgate panel has screw connections which correspond to the slide nuts.

14. The fastening arrangement according to claim 11, further comprising:
a sleeve which is to be applied over the lens to the camera or the camera holder before mounting of the spoiler, the sleeve being in contact with the recess of the spoiler at least on part regions thereof after mounting and not being in contact with the lens.

15. The fastening arrangement according to claim 14, wherein
the sleeve has clips, by way of which the sleeve is fastenable to the camera holder in order to fix the camera on the camera holder.

16. The fastening arrangement according to claim 11, further comprising:
a washer nozzle fastened to the vehicle body or the tailgate panel adjacently to the camera, wherein the spoiler has a separate recess for the washer nozzle.

17. A method of mounting a camera on a vehicle which comprises utilizing the fastening arrangement according to claim 11 on a rear side of a vehicle.

18. The method according to claim 17, wherein
the fastening arrangement and the spoiler are arranged as an upper rear spoiler or a lower rear spoiler

19. A vehicle comprising the fastening arrangement according to claim 11.

20. A method of mounting a fastening arrangement for a camera disposed inside a spoiler to be fastened to a region of the vehicle body or a tailgate panel, comprising:
first, fastening the camera in a water-tight manner in a camera holder;
second, fastening the camera holder in a water-tight manner to the vehicle body or the tailgate panel of the vehicle; and
third, mounting the spoiler to the vehicle body or the tailgate panel over the camera holder, with a recess of the spoiler over a lens of the camera in such a way that, after the mounting, the recess is aligned on the lens in relation to the vehicle body or the tailgate panel.

21. The method according to claim 20, further comprising:
Applying a sleeve over the lens to the camera or the camera holder before mounting of the spoiler, the sleeve being in contact with the recess of the spoiler at least on part regions thereof after mounting, and not being in contact with the lens.

22. The method according to claim 20, further comprising:
fastening a washer nozzle to the vehicle body or the tailgate panel adjacently to the camera, wherein the spoiler has a separate recess for the washer nozzle.
